(19) United States
(12) Patent Application Publication
(10) Pub. No.: US 2025/0033731 A1
(43) Pub. Date: Jan. 30, 2025

(54) A MOUNT TO CONNECT A POWER UNIT TO A BIKE

(71) Applicant: Swytch Technology LTD, London (GB)

(72) Inventors: Oliver MONTAGUE, London (GB); Dmitro KHROMA, London (GB)

(73) Assignee: Swytch Technology LTD, London (GB)

(21) Appl. No.: 18/713,827

(22) PCT Filed: Nov. 28, 2022
(86) PCT No.: PCT/GB2022/053011

§ 371 Date: May 28, 2024

(30) Foreign Application Priority Data
Nov. 29, 2021 (GB) 2117164.0

(51) Int. Cl. B62J 43/23; B62J 43/13; B62J 50/22; H01M 10/48; H01M 50/249; H01M 50/262

(52) U.S. Cl. CPC B62J 43/23; B62J 43/13; B62J 50/22; H01M 10/48; H01M 50/249; H01M 50/262; H01M 2220/20

(57) ABSTRACT

A mount for connecting a power unit to a bike-mounted power apparatus, the mount comprising: an attachment device configured to mechanically connect the mount to a bike, the attachment device being for attaching the mount to the handlebars of a bike; a power unit connector configured to mechanically and electrically connect a power unit to the mount; wherein the power unit connector comprises: an electrical interface configured to electrically connecting to a power unit; and first and second opposing surfaces for gripping a power unit therebetween. A modular power apparatus for a bike includes the mount and a power unit.

### FIELD

The present disclosure relates to electric power supplies for a push-bike.

### BACKGROUND

There is an increasing appetite for electric powered or power-assisted push bikes. Traditionally, bikes are manufactured either to have the option to use electric power to power the bike, or not. More recently, bike conversion kits have been made available that allow users to convert a traditional push bike into an electric powered bike.

Electric bikes—including bikes specifically designed to be electric powered and traditional bikes converted to use electric power—suffer from a lack of flexibility. In order to maximise the range of the electric drive system, known systems employ a single large battery.

Being tied to the use of a large battery has many disadvantages. Such batteries are often unattractive and so detract from the appearance of the bike. The additional weight of these batteries makes it difficult to use the bike without electric power assistance. The size and weight of the battery not only makes it more difficult to handle the bike—for example when taking it on and off public transport—it also makes it impractical to remove and store the battery to use the bike without electric power assistance.

The use of a single large battery impacts the use efficiency of the system. Large power supplies are not required for shorter trips, and the unused energy in the battery, as well as the additional energy used to drive the unnecessary additional battery weight results in inefficient energy usage. Once drained, larger batteries take longer to charge and it is therefore difficult to manage charging and use routines when multiple trips are required over a short period of time.

Furthermore, as battery sizes decrease, the size of the connector becomes increasingly significant as it forms a large proportion of the overall size of the apparatus as a whole. Accordingly, traditional electrical interfaces and connectors are unsuitable or undesirable for use in electric power apparatuses where device footprint is of concern. In some cases the need to provide a large and obtrusive electrical interface can negatively impact the usability of the apparatus as a whole and reduce the functionality of the apparatus.

### SUMMARY OF THE INVENTION

The present disclosure provides a modular power apparatus that overcomes the drawbacks of existing systems. The modular power apparatus of the present disclosure provides a more flexible system for managing electric bike power supply. The modular power apparatus provides a user with the range of a large battery in addition to the convenience of a smaller power supply. It allows a user to select the size of power supply required depending on the specific use case, ensuring that sufficient power is available, while also minimising energy wastage and improving the usability of the electric bike as a whole.

Additionally, the present disclosure provides a more compact mount and power apparatuses. The examples described herein have a smaller footprint than existing arrangements. This is at least in part achieved by the use of the new connector and electrical interface arrangements described herein. These factors contribute to a power apparatus that is truly “pocket-sized” and significantly more portable than existing devices.

According to the present disclosure is a mount for connecting a power unit to a bike-mounted power apparatus.

The mount according to the present disclosure may allow a pocket-sized power unit to be mechanically and electrically connected to a bike, or an electric power system thereof. The mount may be configured to suitably support and present a smaller power unit than those employed by existing designs.

The mount may be used as part of a wider power apparatus for powering a bike. The mount may be electrically connected to an electric motor for driving the bike.

The mount may be configured to control the power output of the motor.

The mount may also be configured to connect to a power unit for supplying power to the electric motor.

The mount may comprise an attachment device configured to mechanically connect the mount to a bike or scooter. The attachment device may be for attaching the mount to the handlebars of a bike or scooter. The mount may further comprise a power unit connector configured to mechanically and electrically connect a power unit to the mount. The power unit connector may comprise: an electrical interface configured to electrically connecting to a power unit; and first and second opposing surfaces for gripping a power unit therebetween.

The mount may be configured to attach to the handlebars of a bike. The attachment device may comprise at least one receiving portion configured to receive a handlebar of a bike or scooter to connect the mount thereto.

The first opposing surface may be provided on a first jaw. The second opposing surface may be provided on a second jaw. The opposing surfaces may be located on an inner surface of the respective jaws, facing each other during use.

The first and second jaws—or the first and second opposing surfaces—may comprise a profile configured to grip an outer profile of a power unit. The first and second jaws may be curved.

The dimensions of the jaws determine the size of power units that can be connected to the mount. The first and second jaws may be configured to grip a pocket-sized power unit. That is, the first and second jaws may be arranged to define a narrow receiving section—suitable for gripping a power unit with a smallest dimension of less than 40 mm, 35 mm, 30 mm or 25 mm. The first and second jaws may be configured to grip a power unit with a dimension parallel to the length of the jaws of less than 40 mm, 35 mm, 30 mm or 25 mm.

Each of the first and second jaws may have a length defined as the distance between a distal tip of the respective jaw and a base that connects the jaw to the rest of the mount. The length of each of the first and second jaws may be less than about 40 mm. Alternatively, the length of the jaws may be less than 35 mm, 30 mm or 25 mm.

The first and second opposing surfaces (or jaws) may be configured to move towards and away from each other. The first and second opposing surfaces may be configured to move between: a gripping arrangement for gripping a power unit between the opposing surfaces; and a release arrangement for releasing a power unit from the opposing surfaces.

The movement of the opposing surfaces towards and away from each other provides a mechanically robust and space-efficient method for supporting a power unit. It also allows a strong connection to be provided once the power unit is located between the opposing surfaces and the surfaces have moved towards each other.

The first or second opposing surface (or jaw) may be configured to rotate towards or away from a corresponding one of the first and second surface. Such an arrangement may be provided where one or both of the first and second surfaces are provided on a jaw arranged to pivot about its base.

The first or second opposing surface (or jaw) may be configured to translate relative to the other of the first and second surface. Such an arrangement may be provided where one or both of the first and second surfaces are provided on a jaw arranged to slide relative to the other opposing surface.

The first and second opposing surfaces may be biased towards each other. The mount may comprise a biasing means to urge one of the first and second opposing surfaces (or jaws) towards the other of the first and second opposing surface (or jaw).

Providing such a biasing machines may improve the grip of power units.

The mount may be configured to receive a power unit between the opposing surfaces and mechanically and electrically connect the power unit to the mount in a single motion.

The power unit connector may be an integral mechanical and electrical connector. The power unit connector may be configured to mechanically and electrically connect a power unit to the mount in a single motion. The mount may be configured to receive a power unit between the opposing surfaces and mechanically and electrically connect the power unit to the mount simultaneously.

The electrical interface may be provided on one of the opposing surfaces. That is, the electrical connection between the power unit and the mount may be provided on the same surface as that which provides the mechanical support/connection to the power unit.

The electrical interface of the mount may be as described anywhere herein. Similarly, comments relating to the electrical interface of the mount may apply equally to the electrical interfaces of the power unit and/or power bridge.

The electrical interface may provide a low profile arrangement. The electrical interface may project from, or be recessed into, the surface on which it is located by less than 10 mm or, preferably, less than 5 mm. The electrical interface may be recessed into the surface on which it is located.

The electrical interface may comprise a seal. The seal may surround electrical contacts of the electrical interface and may reduce fluid ingress into the electrical interface.

The first opposing surface may be an upper surface configured to face downwards during use; and the second opposing surface may be a lower surface configured to face upwards during use. The first and second opposing surfaces may be provided on opposing jaws. Providing the first and second opposing surfaces on opposing jaws provides a particularly beneficial and compact arrangement, and which may be suitable for compact (e.g. pocket-sized) power-supplies.

The electrical interface may be provided on the first opposing surface.

The electrical interface may be provided on a surface facing downwards during use. This may reduce the risk of water or dirt entering and affecting the performance of the electrical interface.

The mount may further comprise a lock. The lock may be configured to move between a locked configuration and an unlocked configuration. In the locked configuration, movement of the power unit connector from the gripping arrangement to the release arrangement may be resisted. In the unlocked configuration, the power unit connector may be free to move from the gripping arrangement to the release arrangement.

The mount may further comprise a release configured to move the lock from the locked to the unlocked configuration.

The lock may resist movement of the opposing surfaces into a release arrangement and, thereby, restrain the power unit in the mount during use—increasing safety and reliability of use.

The lock may comprise a mechanism internal to the mount. The release may allow the lock to move to an unlocked position, and thus may be pressed when a power unit is to be removed from the mount. The release may be a mechanical switch or button. The release may ‘pop out’—and thus be available for pressing—when the mount moves to a locked configuration.

The lock may be configured to automatically move from the unlocked configuration to the locked configuration when a power unit is connected to the mount. Automatic refers to the ability of the lock to move into the locked position without further action by the user.

Automatic locking of the mount increases safety and reliability, by automatically restraining a power unit within the mount once inserted, and minimising the chances of a power unit inadvertently leaving the mount during use.

The lock may comprise a protrusion or pin arranged for abutment with a power unit when a power unit is connected to the mount to move the lock from the locked configuration to the unlocked configuration. The protrusion may facilitate the automatic locking of the mount, by activating the lock upon abutment with a power unit entering the mount.

The mount may further comprise a display. The display may be an LED display. The display may be a dot-matrix LED display. The display may be for indicating a power output or battery level of a power unit connected to the mount. The LED display may be on a side or front of the mount.

The mount may further comprise a user interface. The user interface may be for inputting data or instructions to the power system. The user interface may be a touch screen or one or more buttons. The user interface may be for adjusting the power output level of a power unit connected to the mount.

The mount may further comprise a first part having the attachment device; and a second part having the power unit connector; wherein the first and second parts are configured to attach and detach from one another.

The mount may be formed of a plurality of interconnected parts for assembly. Forming the mount of a plurality of different parts may make assembly of the power apparatus as a whole more straightforward. A first part may be connectable to a bike and a second part connectable to a power unit, before the first and second parts are connected.

The mount may be reconfigurable for attachment to a bike in a plurality of configurations. In a specific example, the mount may be reconfigurable by rotating a first part of the mount with respect to the second part. Or connecting a first part of the mount in a different configuration with respect to the second part of the mount.

The mount may comprise a wireless communication device. The wireless communication device may be a Wifi, Bluetooth™, NFC, Global System for Mobile Communications (GSM) or other wireless communication device. The wireless communication device may be for transmitting diagnostics or performance data, either to a user or a central server. The wireless communication device may be for receiving updates or control instructions, either from a user or central server.

Further according to the disclosure is a power apparatus for a bike or scooter. The power apparatus may comprise a mount as described anywhere herein. The power apparatus may further comprise a power unit. The power unit may be as described anywhere herein.

The power unit may comprise a power level indicator. The power level indicator may an LED indicator or screen. The power level indicator may be on a side or front of the power unit.

The power unit may be a cuboid with a pair of first sides, a pair of second sides and a pair of third sides with an area greater than that of the first sides and less than that of the second sides; wherein one of the third faces is configured to electrically connect to the mount and the power bridge.

The power unit may be configured to fit in a user's pocket.

The power unit may have a maximum length of 250 mm, a maximum width of 120 mm and a maximum depth of 40 mm. The power unit may have a maximum length of 240or 210 mm, a maximum width of 100 mm, and a maximum thickness of 30 mm.

The power unit may comprise an electrical interface for connecting to the power unit connector of the mount. The electrical interface of the power unit may be as described above. The electrical interface of the power unit may be the inverse to that of the mount—that is, if the interface of the mount is a male-type interface, the interface of the power unit may be a female-type interface.

The electrical interface of the power unit may be arranged on a side of the power unit.

The electrical interface of the power unit may provide a low profile arrangement. The electrical interface may proceed project from, or be recessed into, the surface on which it is located by less than 10 mm or, preferably, less than 5 mm. The electrical interface may be recessed into the surface on which it is located.

The power unit may comprise a plurality of cells arranged therein. The power unit may comprise 10 identical cells arranged in a row.

The, or each, power unit may have a capacity of 180 Wh or less, 126 Wh or less, or 100 Wh or less.

The power apparatus may further comprise a power bridge configured to combine a plurality of power units into a single power supply. The power apparatus may be configured such that the power unit can be connected to and disconnected from the mount directly, and a plurality of power units can be collectively connected to and disconnected from the mount via the power bridge, for allowing a user to selectively connect one, or multiple, power units to the mount.

The mount may be for connecting a power supply to an electric motor. The power unit may be configured to mechanically and electrically connect to the power bridge and directly to the mount (although only one at a time). The power bridge and the power bridge may be configured to connect the power unit and a further power unit to combine the power units into a single power supply, and mechanically and electrically connect to the mount.

The mount may be configured to be attached to the handlebars of a bike. The mount may comprise an electrical interface. The power unit may comprise an electrical interface configured to couple with the power bridge and the mount electrical interface.

The power bridge may comprise a first electrical interface configured to couple with the mount electrical interface; a second electrical interface configured to couple with the power unit electrical interface; and a third electrical interface for coupling with a second power unit.

The power apparatus may further comprise a further power unit or units, wherein the further power unit or units are similar to the power unit and the power bridge is configured to mechanically and electrically connect all of the power units to combine the power units into a single power supply.

The power unit and power bridge may be configured to electrically connect to the mount as they are mechanically connected to the mount.

The power bridge may comprise a mutual power bus for electrically connecting a plurality of power units. The power bus may comprising a wrap for holding a plurality of power units.

The power bridge may comprise a case for mechanically and electrically combining the power units.

The power bridge, or case, may comprise a plurality of electrical interfaces for connecting and combining a plurality of power units to form a single power supply.

The power bridge may comprise an integral power unit. The integral power unit may be a power unit provided as part of the power bridge or the case thereof. The first electrical interface of the power bridge may be provided by the integral power unit.

At least one of the power unit and power bridge may comprise a port configured to allow charging or discharging of the power unit. The port may be a USB-C connector.

Further according to the disclosure is a modular power apparatus for a bike, the power apparatus may comprise: a mount for attaching to a bike; a power unit; and a power bridge which may be configured to combine a plurality of power units into a single power supply; wherein the power apparatus may be configured such that the power unit can be connected to and disconnected from the mount directly, and a plurality of power units can be collectively connected to and disconnected from the mount via the power bridge, for allowing a user to selectively connect one, or multiple, power units to the mount.

Also according to the disclosure is a power unit as described anywhere herein.

Further according to the disclosure is a power bridge as described anywhere herein.

### BRIEF DESCRIPTION OF DRAWINGS

FIG. 1 is a perspective view of a modular power apparatus;

FIG. 2 is a perspective view of the modular power apparatus of FIG. 1 attached to a bike;

FIG. 3 is a perspective view of a power unit attached to a bike;

FIG. 4A and 4B are front and rear perspective views of a mount;

FIGS. 5A through 5C are rear perspective views of the mount of FIG. 1 in different arrangements;

FIG. 6 is a perspective view of the power unit of FIG. 1;

FIG. 7 is a partial side view of the power unit of FIG. 1;

FIG. 8 shows the power unit of FIG. 1;

FIG. 9 is a front view of the power bridge and power units of FIG. 1;

FIG. 10 is a side view of a modular power apparatus;

FIG. 11 is a perspective view of the power bridge and power units of FIG. 1;

FIGS. 12A and 12B are perspective views of charging stations;

FIG. 13 is an exploded perspective view of a second power apparatus;

FIG. 14 is an exploded perspective view of a further power apparatus;

FIG. 15 is a perspective view of a power unit;

FIG. 16 is a perspective view of a mount;

FIG. 17 is an underside perspective view of a mount;

FIG. 18 is a perspective view of a power unit and mount in a connected arrangement;

FIG. 19 is a perspective view of a power unit and power bridge; and

FIG. 20 is perspective view of a power apparatus connected to a bike.

### DETAILED DESCRIPTION OF DRAWINGS

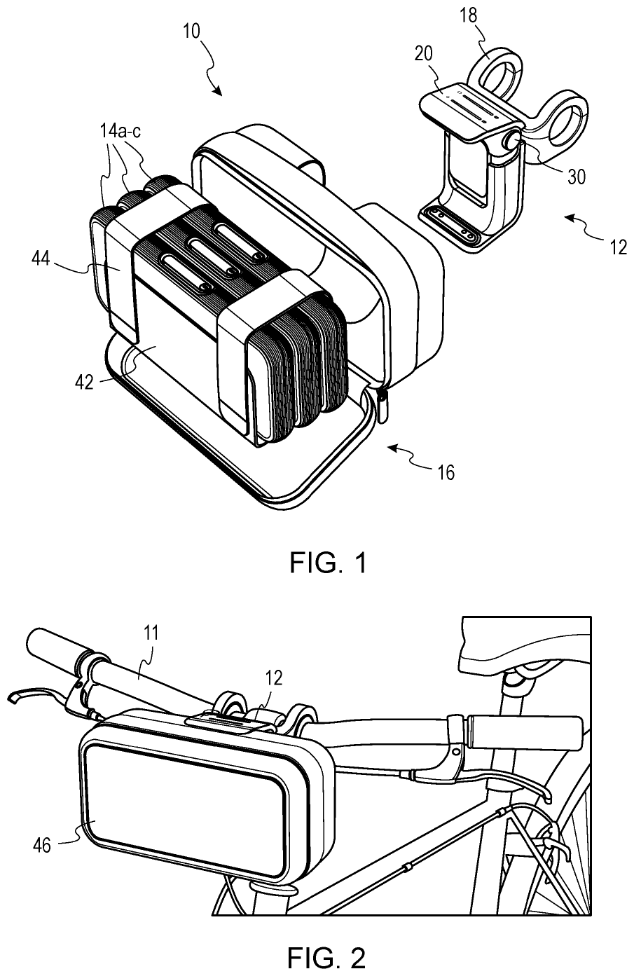

FIG. 1 is a perspective view of a modular power apparatus 10 for an electric bike.

The power apparatus 10 includes a mount 12, a plurality of power units 14a-c and a power bridge 16.

The power apparatus 10 provides a much more efficient and convenient system for conversion of push bikes to electric power. The power apparatus 10 facilitates the attachment and use of a power unit 14 that is much smaller than traditional power units. This power units 14 may be pocket sized, allowing a user to store the power unit 14 in a pocket when not in use. This improvement is provided through the use of a mount 12 having a power unit connector with an electrical interface and first and second opposing surfaces for gripping a power unit 14.

The power apparatus 10 is also configured to provide a user with increased flexibility in powering an electric bike. The power apparatus 10 allows a user to tailor the power capacity of the chosen power supply based on the specific use case, through the use of a plurality of modular power units 14, or modules. By allowing a user to tailor the power capacity to the use case, a much more energy efficient and convenient user experience is provided. The need to carry unnecessary weight associated with excess battery capacity is eliminated. Where only a subset of the total power units 14 are employed, the unused power units can continue to charge.

Broadly speaking, the power apparatus 10 provides a power and control system for connection to an electric motor. When using the power apparatus 10, an electric motor (not shown) provided on the bike is connected to a power unit 14 via the mount 12. The electric motor may be an in-wheel motor and may be powered by the power unit 14. The mount 12 may be configured to provide a user with feedback and control options.

The mount 12 of the present example is configured to be attached to and detached from a user's handlebars 11. The mount 12 is fixed to a user's electric bike or electrically-converted bike. The mount is electrically connected to the bike's motor (not shown). This connection may be a wired connection. The mount 12 is configured to receive and interface with an electric power supply for powering the electric motor.

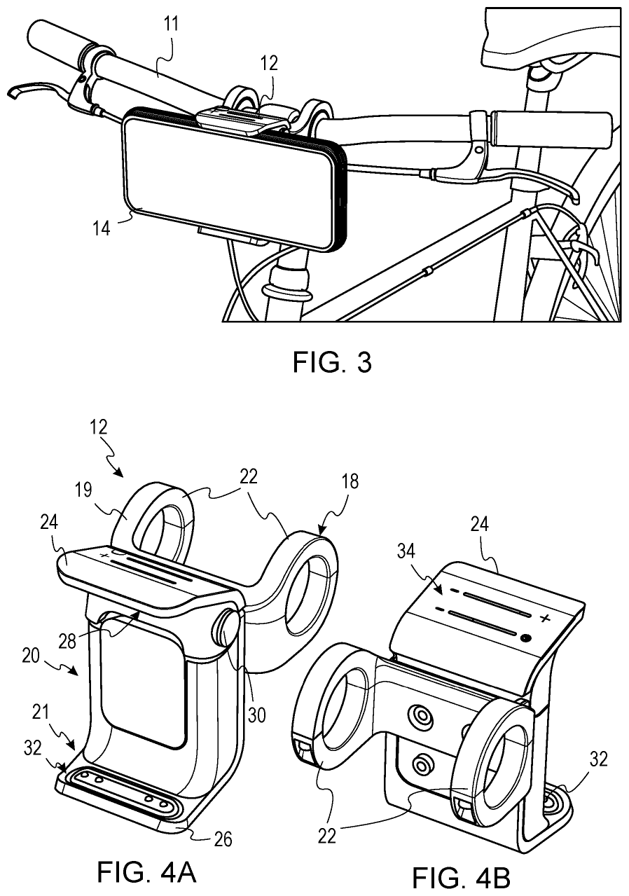

The power supply may be in the form of a single power unit 14, or multiple power units 14 combined into a single supply, as shown in FIG. 1. A single power unit 14 can be connected to the mount 12 (as shown in FIG. 3) to provide a power capacity of a first level. Alternatively, multiple power units 14a-c may be combined and connected to the mount 12 as shown in FIGS. 1 and 2. Combining multiple, for example three, power units 14a-c into a single power supply may provide a larger (e.g. threefold) power capacity compared to connecting only a single power unit 14, thus increasing the range of the bike under electric power. In order to combine multiple power units 14 in a single power supply, a power bridge 16 is provided. The power bridge 16 allows a plurality of power units to be electrically connected and combined into a single supply, for connection to the mount 12.

Referring now to the mount 12 as depicted in FIGS. 1, 4A-4B and 5A-5C the mount 12 comprises an attachment device 19 for attaching the mount to the bike. In the present example, the attachment device 19 comprises two pairs of arcuate sections arranged to attach and separate from each other to form loops 22 arranged to selectively hold and release the user's handlebars.

The mount 12 further includes a power unit connector 21 that mechanically and electrically connects a power unit 14 (or multiple power units 14 via a power bridge 16).
a first part 18 and a second part 20. The first part 18 of the mount 12 is arranged to connect to a bike. In this case, the first part 18 is configured to attach to the handlebars of a bike and the second part 20 is configured to electrically and mechanically interface with a power unit 14 or power bridge 16.

The first 18 and second part 20 are configured to attach to and detach from each other, for example to allow a user to more easily replace, clean or store the second part 20 of the mount 12.

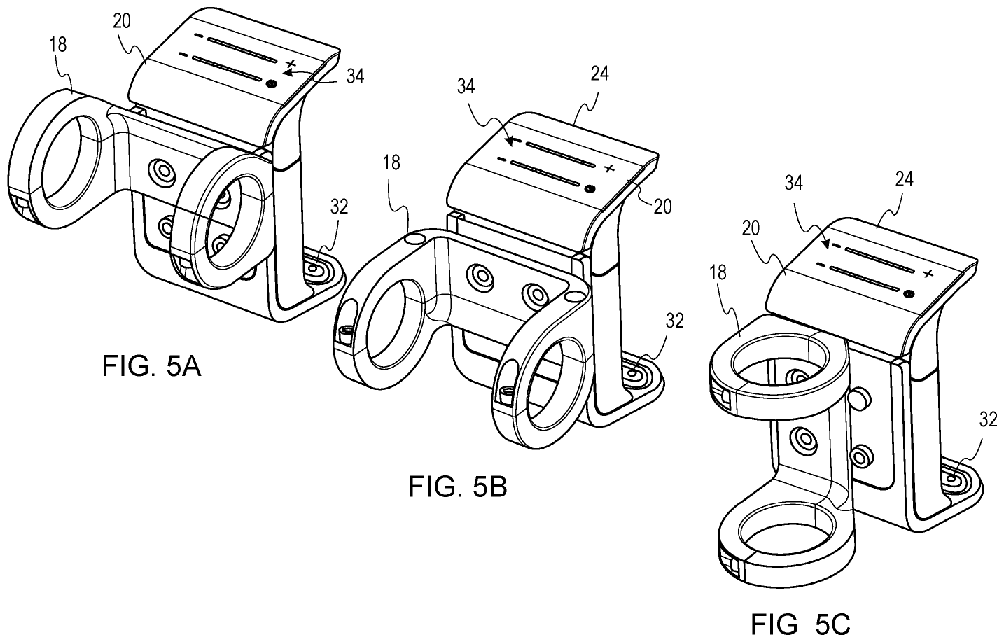

The first part 18 of the mount 12 is releasably connectable to a rear side of the second part 20 of the mount 12, for example by screws or other fastening means. As shown in FIGS. 5A to 5C, the first part 18 of the present example is asymmetric and can be connected to the second part 20 of the mount 12 in different arrangements, allowing a user to customise the placement of the mount relative to the handlebars. In FIG. 5A the second part 20 sits slightly lower relative to the attachment device of the first part 18 compared to the relative positions in FIG. 5B. In FIG. 5C, the first part 18 has been rotated by 90 degrees relative to the second part 20.

The second part 20 of the mount 12 is configured to support and connect to a power unit 14 or plurality of power units 14 via a power bridge 16. This is facilitated by the power unit connector 21.

As seen in FIG. 4A, the power unit connector 21 comprises first and second opposing surfaces. The opposing surfaces are arranged to grip a power unit therebetween. This gripping action supports the power unit 14 (or power bridge 16) in the mount 12.

In the example of FIG. 1, the mount 12 comprises a first 24 and second jaw 26. The opposing surfaces are provided on inner sides of the (opposing) jaws. In the shown arrangement, the jaws form opposing upper 24 and lower 26 jaws. The upper 24 and lower 26 jaws are arranged to grip opposing sides of a power unit 14 or power bridge 16.

The upper 24 and lower 26 jaws are configured to move towards each other to a gripping arrangement and away from each other to a release arrangement to hold and release the power unit 14 or power bridge 16. In the example shown, the upper jaw 24 is configured to rotate about a hinge to allow a power unit 14 or power bridge 16 to enter the jaws, before rotating back to clamp the power unit 14 or power bridge 16 between the jaws.

In other examples according to the disclosure, the jaws 24, 26 may elastically deflect or the power unit connector may have a sliding mechanism to provide the movement of the jaws between the gripping and release arrangements.

The jaws 24, 26 have a length proportional to the depth of a single power unit 14. The length of the jaws 24, 26 may be defined as the distance that the jaws 24, 26 protrude from a body of the mount 12. In the present example, the jaws 24, 26 have a length of less than about 40 mm (or, optionally, less than about 35 mm, 30 mm or 25 mm). The width of the jaws 24, 26 is greater than their length. The small length of the jaws 24, 26 ensures that the footprint of the mount 12 is minimised. In particular, the length of the jaws 24, 26 is proportional to the depth of the power unit 14. As such, the small footprint of the power unit 14 (for example allowing it to be stored in a user's pocket) may be achieved through the use of opposing surfaces for gripping the power unit 14 and optionally using opposing jaws 24, 26 with a length of less than about 40 mm.

In the example of FIG. 1, the jaws 24, 26 are biased towards each other. The mount 12 comprises a biasing device for biasing the jaws 24, 26 towards each other.

The mount 12 is configured to electrically and mechanically connect to a power unit 14 (or a plurality of power units 14 via a power bridge 16) in a single motion. That is, the power unit connector 21 is configured to simultaneously mechanically and electrically connect the mount 12 to the power unit 14.

In use, a power unit 14 (or multiple power units 14 and a power bridge) is inserted into the power unit connector 21 by pushing the power unit 14 between the opposing jaws 24, 26. Movement of the power unit 14 into the space between the jaws 24, 26 urges the jaws 24, 26 away from each other, from a gripping arrangement towards a release arrangement (against the biasing action). Once the power unit 14 is fully inserted into the mount 12, the jaws 24, 26 move back to the gripping arrangement under the action of the biasing means and the power unit 14 is mechanically and electrically engaged simultaneously.

The mount 12 comprises a lock for holding the power unit connector 21 in a gripping arrangement—that is, the lock can resist movement of the jaws 24, 26 away from each other. Specifically for the present example, the mount 12 has a lock that retains the upper jaw 24 in a lowered or gripping arrangement. The lock is configured to avoid inadvertent release of a power unit 14 or power bridge 16, for example during use when riding over a bump.

The lock can be moved between a locked configuration, in which separation movement of the jaws 24, 26 is resisted; and an unlocked configuration, in which the jaws 24, 26 are free to move away from each other to release a power unit 14.

The lock may be employed in a number of ways depending on the specific design of the power unit connector 21. In the present example, the lock is located inside the mount 12. The lock is engaged (i.e. moved to a locked configuration) when a protrusion 28 located on an inner surface of the jaws 24, 26 of the mount 12 (not visible in the Figures) is activated by movement of a power unit 14 or power bridge 16 into the jaws 24 26. The power unit 14 or power bridge 16 presses the protrusion 28 as it is located in the jaws 24 26 and the jaws 24 26 close around opposing sides of the power unit 14 or power bridge 16. This depression of the protrusion 28 urges the lock into an engaged arrangement. Once in an engaged arrangement, the lock resists rotation of the upper jaw 24 to prevent the jaws from disengaging and releasing the power unit 14 or power bridge 16 located therein.

To disengage the lock and allow the upper jaw 24 to rotate and release the power unit 14 or power bridge 16, a button 30 is provided on the side of the second part 20. When a user presses this button 30, the lock is disengaged, the upper jaw 24 is free to rotate relative to the lower jaw 26 and the power unit 14 or power bridge 16 can be removed. In other examples, the protrusion 28 and button 30 can be realised by alternative means for moving the lock between a locked and unlocked configuration.

The power unit connector 21 of the mount 12 comprises an electrical interface 32. The electrical interface 32 is configured to engage and provide an electrical connection with the power unit 14 and the power bridge 16. The power unit 14 and power bridge 16 each comprise a corresponding electrical interface for connection with the mount electrical interface 32.

The electrical interface 32 of the mount 12, as well as on the power unit(s) 14 and power bridge 16 have a low profile. The electrical interfaces protrude a maximum of 5 mm from the surface on which they are located. The electrical interface 32 comprises a seal located around is periphery to resist water ingress.

As discussed above, the mount 12 is configured such that the power unit 14 and power bridge 16 can electrically and mechanically connected to the mount simultaneously—for example as part of a single motion. The power apparatus 10 is configured such that the electrical interfaces of the mount and power unit or power bridge are connected while the power unit 14 or power bridge 16 is mechanically connected (e.g. by being inserted into), the mount 12.

The mount electrical interface 32 is provided on one of the opposing surfaces of the jaws 24, 26. In the example shown the electrical interface 32 is provided on the lower jaw 26 of the mount 12. However, in other examples the electrical interface may be provided on an upper jaw, for example to minimise water ingress.

On an upper surface of the mount 12 of FIG. 1, a display 34 is provided. In the present example, the display 34 comprises an electronic display. The display 34 indicates to a user the current power output level of the modular power apparatus 10 (e.g. which may correspond to the speed of the electric bike) and the remaining power capacity of the power supply (e.g. which may correspond to the remaining possible range for the electric drive system).

In an alternative example, the mount 12, or display 34, may be configured to receive user inputs—for example to control the power output of the power apparatus and thus the speed of the electric drive system. The mount 12 may comprise a user interface for this purpose.

The mount 12 further comprises, for example on a rear side of the mount 12, a connection point for connection to an electric motor for the bike. For example, a power socket may be provided for receiving a power cable leading to the motor. The mount 12 may be directly connected to the motor, or indirectly connected, for example via a control module. Power from the power units 14 is provided to an electric motor of the bike, via the mount 12.

The mount 12 may comprise a control module for processing operating instructions, performance data, input data and/or other data during use of the device. The mount 12 may comprise a wireless communication device for communicating data (e.g. receiving input commands or sending control data) with a user device (e.g. a phone) or a central server. This is described in more detail below.

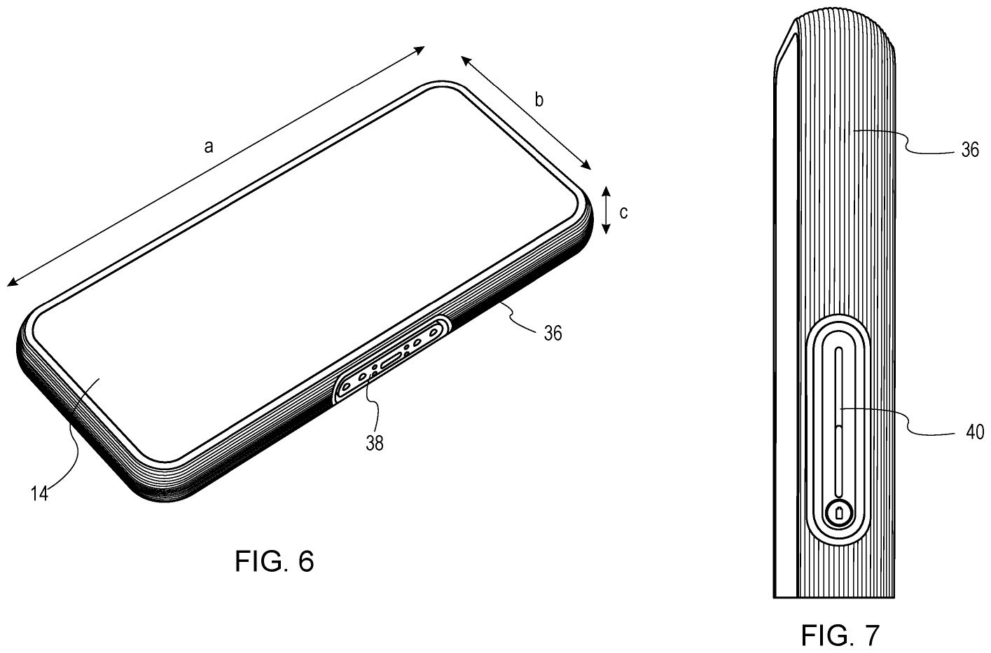

Referring now to FIGS. 6 through 8, the power unit 14 is shown in more detail. The power unit 14 of the present example is a battery module, for storing and supplying electric power to the bike's electric motor.

The power unit 14 of the present example is generally rectangular in shape, with a length ‘a’, width ‘b’ and depth ‘c’. The length is greater than the width which is greater than the depth. However in other examples the power unit 14 may be of a different shape, for example cylindrical or an extruded shape.

In the shown example, the power unit 14 has rounded corners with a tactile surface 36 running around the edges of the device. The tactile surface 36 is a ribbed rubberised profile.

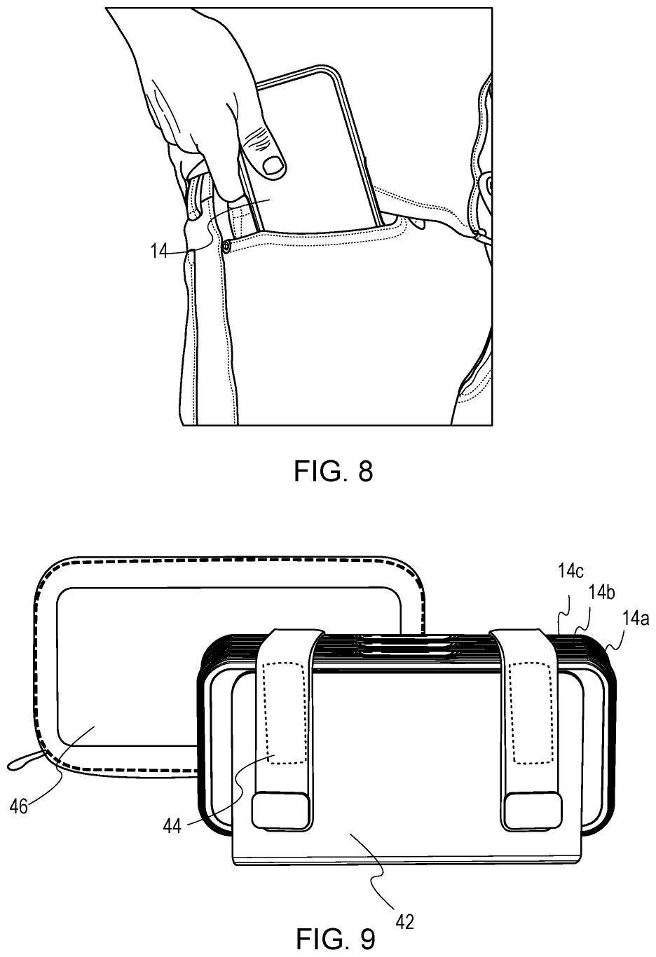

As shown in FIG. 8, the power unit 14 is dimensioned so as to fit in a typical user's pocket. The dimensions of the power unit 14 shown in FIG. 8 are 209 mm×92 mm×25 mm. Alternative examples may have dimensions of up to 240 mm, by up to 100 mm, by up to 30 mm. For example, another example providing higher capacity than that shown in FIG. 8 has dimensions 240 mm×92 mm×28 mm.

The power unit 14 comprises an electrical interface 38 on one its sides, as shown in FIG. 6. The electrical interface 38 is configured to engage the electrical interface 32 of the mount 12. In the present example, the electrical interface 38 is provided on one of the longest sides of the power unit 14. The electrical interface 38 is positioned such that an electrical connection is made between the mount 12 and the power unit 14 as the power unit is inserted into the jaws of the mount 12.

The power unit 14 may be configured to act as a power bank, and thus be charged and discharged. The power unit 14 may be charged directly—for example via a USB connection, as in the shown example, or via the standard power connector (i.e. that which is also used to connect the device to the motor). In other examples, however, the power units may be configured to be charged wirelessly, for example inductively. The power unit 14 may be configured to be used as a power supply for devices other than an electric bike (e.g. in addition to being used to power an electric bike). For example, the power unit 14 may be configured to connect to and charge a personal device, such as a user's phone. A user may use the modular power apparatus to charge their device at the same time as driving the motor of an electric bike. The mount 12, power unit 14 or power bridge 16 may comprise an electrical interface for connecting to a user's device, such as a phone.

The electrical interfaces of the mount 12, power unit 14 and/or power bridge 16 may be any available connector suitable for conveying electrical power for driving an electric bike. Connectors used in the modular power apparatus may incorporate magnets in order to facilitate easier and more robust connection. Examples of suitable connectors include Pin & Socket Power Connectors, USB connectors, pogo pin connectors, blade and clip connectors, for example such as those provided by Rosenberger™ and CLE Technology Co, Ltd™.

The electrical interfaces of the mount 12, power unit 14 and/or power bridge 16 may comprise a low-profile interface. The interfaces may protrude or be recessed less than 5 mm into the surface of the mount 12, power unit 14 or power bridge 16. The electrical interfaces of the mount 12, power unit 14 and/or power bridge 16 may comprise a seal (e.g. a rubber seal) surroundig the electrical contacts to control the ingress of water.

The power unit 14 further comprises a display 40. In the present example, the display 40 is an electronic display. The display 34 indicates to a user the remaining power capacity of the power supply (e.g. which may correspond to the remaining possible range for the electric drive system).

FIG. 3 shows the power unit 14 connected to the mount 12 in order to power an electric bike. The mount 12 is connected to the handlebars 11 as described herein and the power unit 14 is gripped by the jaws 24 26 of the mount 12. In use, a user connects the first part 18 of the mount 12 to the handlebars 11 using the attachment device. The second part 20 of the mount is then connected to the first part 18 and a motor power cable is connected to the mount 12 to connect the mount 12 to the electric motor. When a user wants to use the bike, the user inserts a power unit 14 into the mount 12. Connecting a power unit 14 to the mount 12 is very straightforward. The power unit 12 is angled to align the electrical interfaces 32, 38 of the mount 12 and power unit 14. The power unit 14 is then pushed into engagement with the mount 12. The upper jaw 24 is rotated upwards as the power unit 14 is inserted and then rotates back towards the lower jaw 26 once the power unit 14 is fully inserted. As the upper jaw 24 rotates towards the lower jaw 26, the locking mechanism engages, restraining the upper jaw 24 in an engaging arrangement to prevent the power unit 14 from inadvertently falling out of the mount 12 during use.

The power unit 14 of the present example has a maximum capacity of 100 Wh. Such a capacity allows this power unit 14 to meet the current regulations relating to air travel, such that this power unit 14 can be taken on flights. Other examples of power units according to the disclosure may have a capacity of up to 126 Wh or 180 Wh. The range of the electric power system when using a single power unit 14 may be up to 5 miles, up to 10 miles, or up to 15 miles. Using a single power unit 14 minimises energy wastage and unnecessary weight when only a short journey is required. Unused power unit 14 can, for example, be left at home or stored in a backpack. Once the journey is complete, the power unit can be safely and conveniently stored in a pocket.

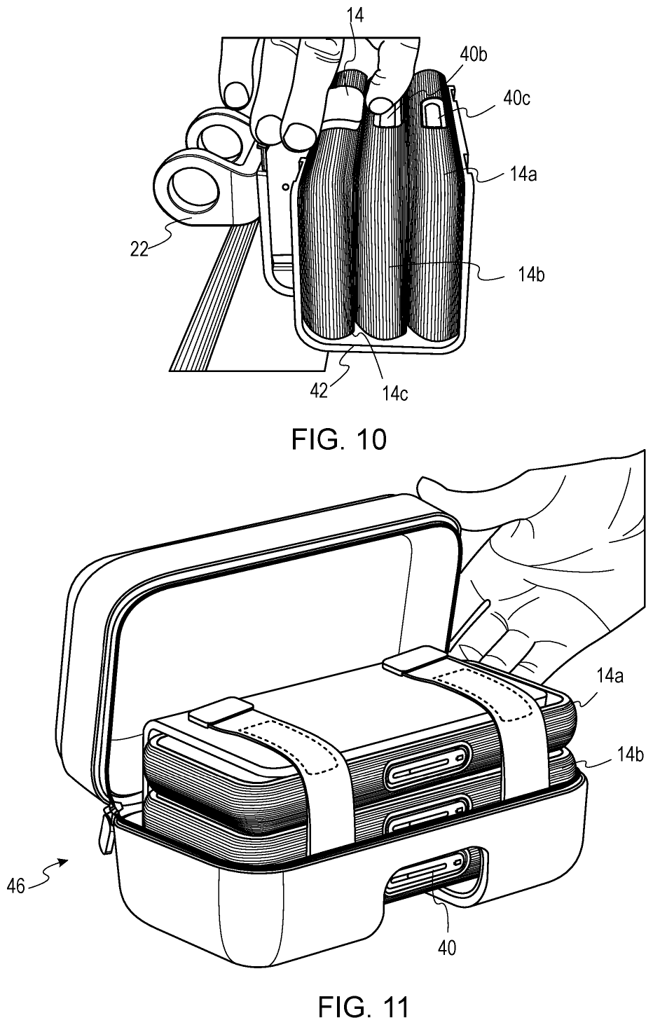

Turning now to FIGS. 1, 9, 10 and 11, a power bridge 16 connecting a plurality of power units 14 is shown. The power bridge 16 is configured to connect—both electrically and mechanically—a plurality of power units 14 together to form a single power supply. This single power supply can then be connected to the mount 12 in the same way as a single power unit 14.

The power bridge 16 is configured to electrically connect to a plurality of power units 14. In the present example, the power bridge 16 is configured to combine a maximum of three power units 14.

The power bridge 16 comprises a plurality of electrical interfaces to connect to each of the power units 14 being combined.

In the present example, the power bridge 14 includes a mutual power bus 42 to which the power units 14 are electrically connected. The power bus 42 shown in the Figures is a substantially U-shaped component, comprising three electrical interfaces on its inner side, configured to connect to the corresponding electrical interfaces on the three power units 14a-c. The electrical interfaces are as described elsewhere herein.

The power units 14a-c are connected to the mutual power bus 42 to electrically connect and combine the power units 14a-c. The power bridge 16 also comprises a wrap 44 configured to wrap around the three power units 14 to mechanically hold them in position. The wrap 44 of the present example includes Velcro™ arranged to engage a complimentary Velcro™ pad on the power bus 42.

On the outside of the mutual power bus 42 an electrical interface is provided that is configured to connect to the electrical interface 42 of the mount 12. As such, the power bridge 16 has a single electrical interface configured to provide a single connection point to the mount 12.

In the present example, the power bridge 16 is configured to arrange the power units 14 vertically when connected to the mount 12. That is, in some examples the power units 14 can be arranged next to each other (e.g. when the power bridge 16 is connected to the mount 12). In other arrangements, however, the power units 14 may be arranged horizontally when connected to the mount 12, for example such that part of each power unit 14 is located between the jaws of the mount 14. That is, the power units 14 can instead be arranged in a stacked arrangement within the power bridge 16 (e.g. when the power bridge 16 is connected to the mount 12).

The power bridge 16 further comprises a case 46, configured to hold the mutual power bus 42 and power units 14 held therein. The case 46 protects the power units 14 from rain and other adverse conditions during use. The case 46 comprises two parts that can be opened and closed by a zip.

The case may comprise a cut-out arranged to expose the power bridge's electrical interface, to allow connection of the power bridge 14 to the mount 12 when the power units 14 and mutual power bridge 42 is located in the case 46.

The case may comprise a cut-out arranged to expose the display 40 of one, or multiple, of the power units 14. This may allow a user to monitor the power level of the power unit 14 and thus power supply as a whole during use.

In order to use the modular power apparatus when the distance to be travelled is longer than the range provided by a single power unit 14, multiple power units 14 may be employed. To do so, two or three (or in other examples more than three) power units 14 are combined into a single power supply. This is achieved by connecting the power units 14 to the mutual power bus 42 of the power bridge 16. The power units 14 are electrically connected to the connectors on the inside of the power bus 42 and are mechanically fastened to the power bridge 16 and each other using the wrap 44. The power units 14 and power bus 42 is then inserted into the case 46 for protection. This is then connected to the mount 12 in the same way as a single power unit 14. The rotation (or other relative movement) of the upper jaw 24 facilitates the connection of the power bridge 16 and multiple power units 14, despite the slight difference in geometry of the combined power supply compared to a single power unit 14.

FIG. 2 illustrates a combined power supply including three power units 14 connected to the handlebars 11 of a bike. FIG. 10 shows three power units 14a-c connected to the mutual power bus 42 which is in turn connected to the mount 12.

In some examples, the mount 12 may comprise a wireless communication device, for example Wi-Fi or Bluetooth™. The mount 12 may be configured to wireless connect to a user's device (e.g. mobile phone), or to a remote central server.

The modular power apparatus 10 may be configured to receive operating instructions remotely. For example the modular power apparatus 10 may be configured to allow a user to control the power output of the power units/supply—and hence the speed of the motor—using their phone. The mount 12 may be configured to receive remote instructions relating to the operation of the modular power apparatus 10.

The modular power apparatus 10 may be configured to communicate with a remote server. The modular power apparatus 10 may be configured to allow remote diagnostics and remedial actions to be taken in relation to the apparatus, instructed remotely—for example by the owner or manufacturer.

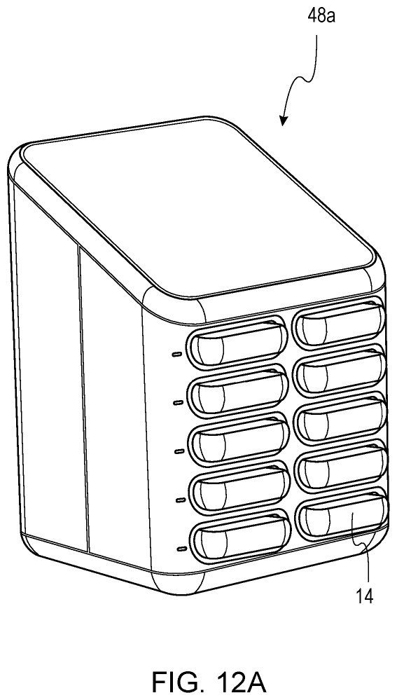

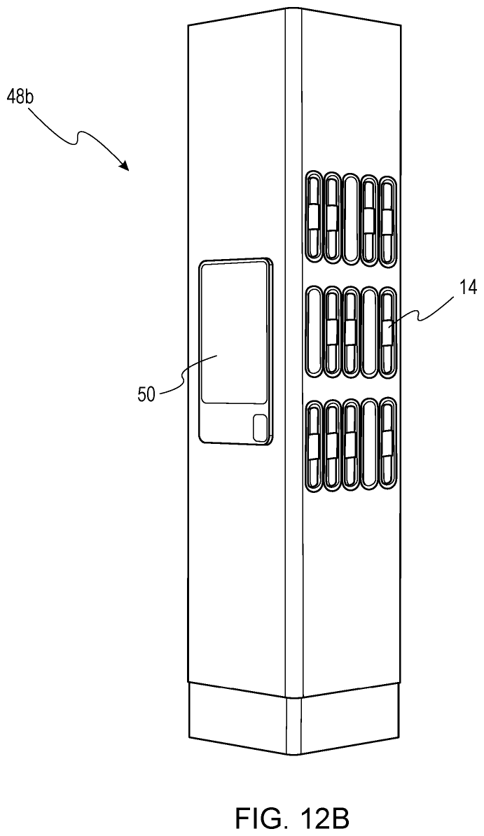

FIGS. 12A and 12B show charging stations for use with the modular power apparatus. The charging stations 48a-b may be personal charging stations owned by a private individual, or communal charging stations 48a-b owned by a local authority, for example city council. The charging stations 48a-b are configured to facilitate simultaneous charging of multiple power units 14. Both charging stations 48a-b comprise a plurality of ports into which power units 14 can be inserted. The charging stations 48a-b are connected to a power source and charge the power units 14 located in the slots.

The charging station 48b of FIG. 12B further comprises a display 50 for displaying information to a user and optionally to receive instructions from a user. The display 50 is configured to display charging information about the power units 14 as well as other relevant information to a user—for example relating to other nearby charging stations or cycling routes.

The charging stations 48a-b may facilitate a networked or communal system of electric bikes powered using the modular power apparatus described herein.

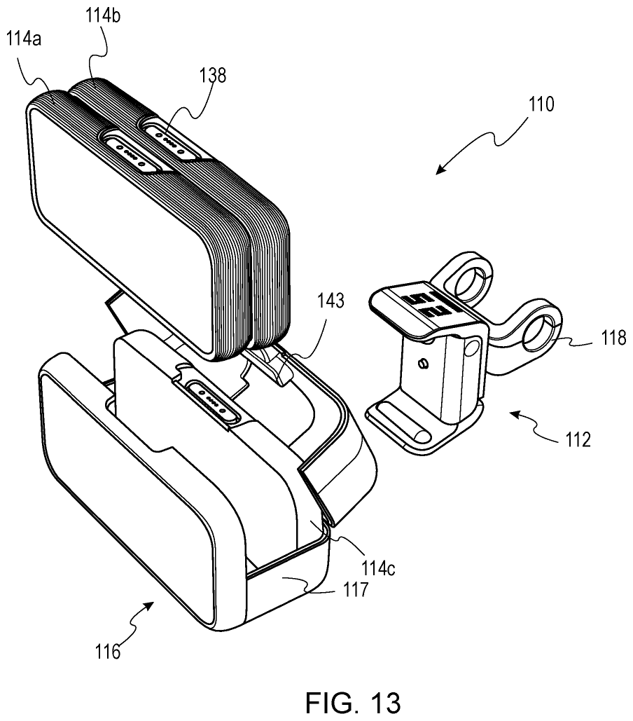

FIGS. 13 through 20 show additional examples of a power apparatus, mount, power unit and power bridge. Features corresponding to those of FIGS. 1 through 12B are designated using corresponding reference numerals advanced by 100. Unless stated otherwise, the comments provided above with respect to features of FIGS. 1 through 12B apply, mutatis mutandis, to corresponding features of FIGS. 13 through 20.

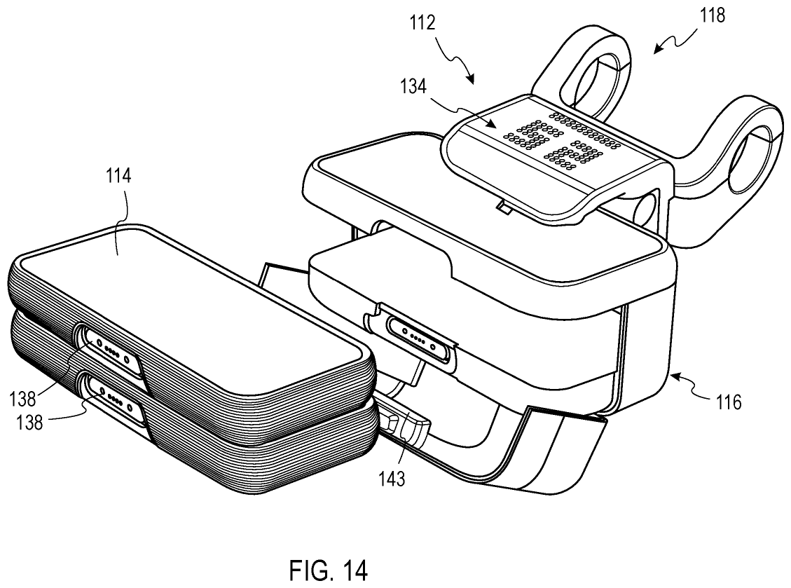

Turning now to FIGS. 13 and 14, a power apparatus is shown. The power apparatus 110 includes a mount 112 for connection to a bike or scooter, a plurality of power units 114a-c and a power bridge 116 for combining the power units 114 for attachment to the mount 112.

The power bridge 116 comprises a case 117 for holding and electrically connecting to the power units 114.

The power bridge 116 comprises an integral power unit 114c. The integral power unit 114c is similar to the other power units described herein, except it is structurally and functionally connected with the power bridge 116. As such, the power bridge 116 always comprises one power unit 114c and is configured to receive and combine a further two power units 114a, 114b.

The power bridge 116 comprises an electrical interface 138 for connection with the mount 112. The electrical interface 138 of the power bridge 116 is provided by the integral power unit 114c and is the same as those described elsewhere herein.

As described elsewhere herein, the electrical interface 138 (both of the integral power unit 114c and other power units 114a, 114b) has a very low profile, and this provides a very compact arrangement and allows the power units to be pocket-sized. In the particular arrangement the electrical interface(s) 138 is (are) recessed into the side of the corresponding power unit(s). In other arrangements, or on the corresponding male-type electrical interface (e.g. that located on the mount 112), the electrical interface may protrude from a surface on which it is located by less than 5 mm.

When a plurality of power units 114 are located inside of the case 116 of the power bridge 116, the electrical interface 138 (of the integral power unit 114c) provides the single electrical connection between the plurality of power units 114 and the mount 112.

The case 117 comprises a plurality of electrical interfaces 143 arranged to connect the power bridge 116 to the power units 114 to form a single power supply. When a plurality of power units 114 (e.g. two power units 114a, 114b) are located inside the case 116, they are electrically connected to the power bridge by means of the internal electrical interfaces 143, to form a single power supply. The single power supply is then connected to the mount 112 by means of the electrical interface 138 of the integral power unit 114c.

The case additionally comprises an electrical interface (not shown) for connection to the mount 112. The case 117 of the power bridge 116 comprises cut-outs at certain locations to facilitate interconnection and to ease handling.

In FIG. 14, the power bridge 116 is shown in a “stacked” configuration, wherein the power units 114 are stacked in the direction of the spacing of the mount's jaws, such that each of the power units 114 is at least partially located within the jaws 124, 126 of the mount 112. This arrangement is shown schematically only.

In an alternative arrangement (e.g. that alluded to in FIG. 13), the power bridge 116 may instead be arranged in a standing configuration whereby the power units 114 are arranged next to each other when connected to the mount 112, with only a single power unit 114 (e.g. the integral power unit 114c) located in the jaws. The mount 112 may connect to a power unit 114 through a cut-out in the case 117. The mount 112 comprises an attachment device for attachment to the handlebars of a bike, as previously described.

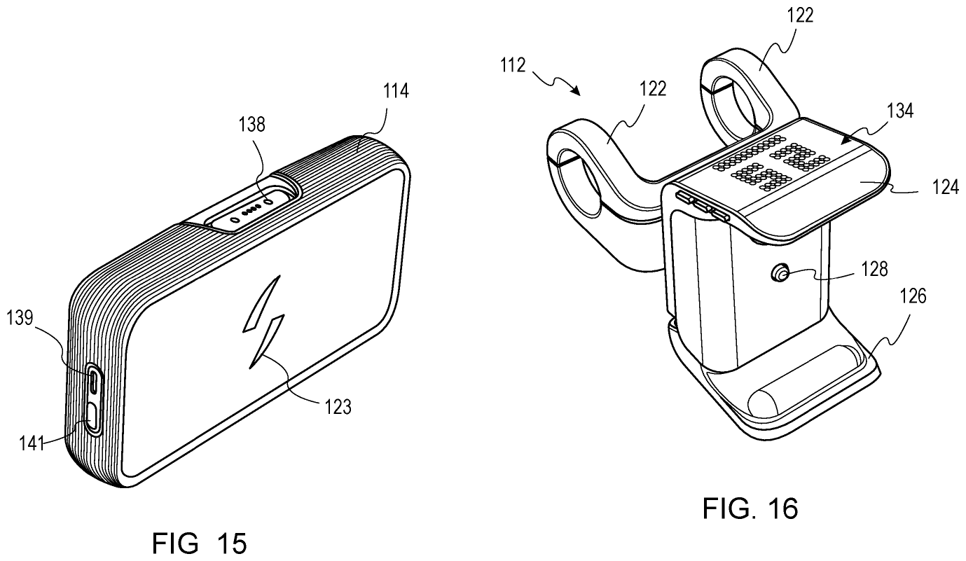

FIG. 15 shows a power unit 114. The power unit 114 includes an electrical interface 138 on its upper surface (which is along a lengthwise side of the power unit). Additionally, the power unit 114 comprises a USB-C charging port 139 and a power on/off button 141 on one of its ends. This may allow a user to charge a user device (e.g. phone) when the power unit 114 is connected to the mount 112.

The power unit 114 further comprises an LED power-level indicator 123 in the form of a logo to indicate the amount of power left in the power unit 114 to a user.

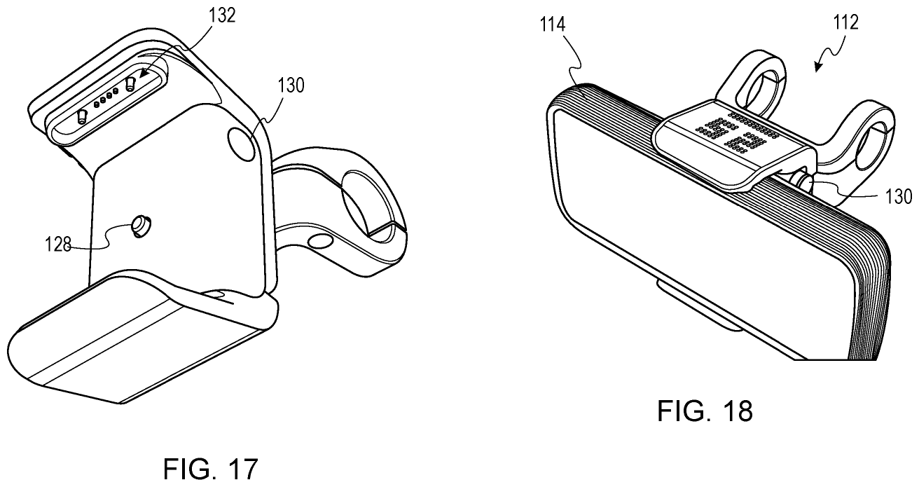

FIGS. 16 and 17 depict a mount 112. The mount 112 is generally consistent with that described in relation to FIGS. 1 through 12B. The mount 112 includes an LED matrix-dot display on its upper surface. The display may be configured to show a motor power output or a speed setting of the power apparatus 110.

In the examples of FIGS. 13 through 20, the electrical interface 132 of the mount is arranged on the underside of an upper jaw 124, as seen in FIG. 17.

As described above, the mount 112 comprises a lock. The mount 112 has a pin or protrusion 128 which protrudes horizontally from a back face of the mount 112. The pin is arranged to engage a power unit 114 connected to the mount 112. A power unit 114 connected to the mount 112 depresses the pin 128 which engages the lock, moving the lock to the locked configuration. In the locked configuration, movement of the jaws 124, 126 away from each other is resisted by the lock.

When the lock is in the locked configuration, a release 130 protrudes from a side of the mount 112 (see FIG. 18). Pressing the release 130 moves the lock into the unlocked position, allowing the jaws 124, 126 to move away from each other, releasing the power unit 114.

FIG. 18 shows a power unit 114 located in a mount 112.

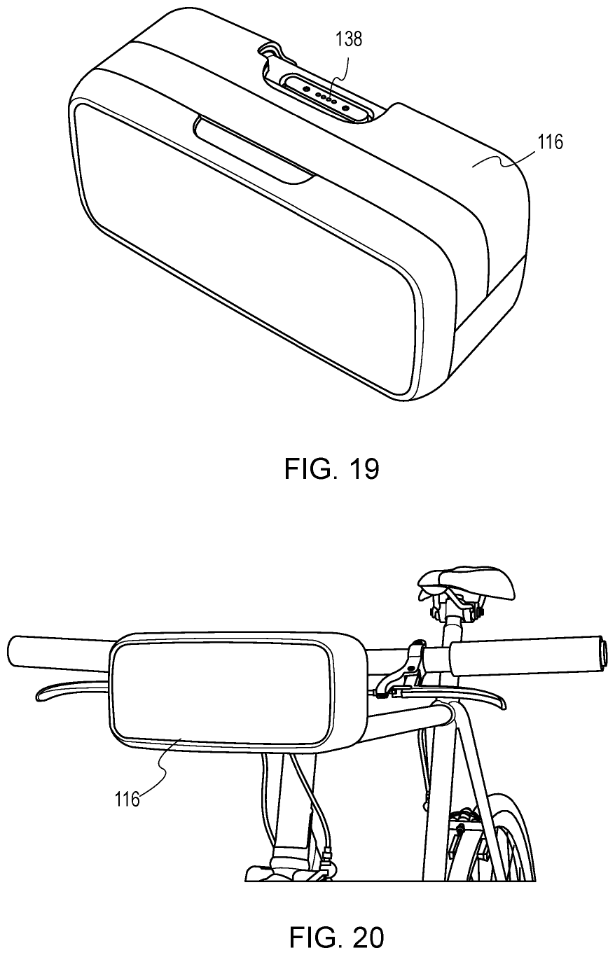

FIG. 19 shows a plurality of power unit 114 located in the case 117 of the power bridge 116.

FIG. 20 shows a power bridge 116 comprising power units 114 attached to a bike via mount 112.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made. The accompanying claims and their equivalents are intended to cover such forms or modifications as would fall within the scope of the invention defined by the claims.

1. A mount for connecting a power unit to a bike-mounted power apparatus, the mount comprising:
an attachment device configured to mechanically connect the mount to a bike or scooter, the attachment device being for attaching the mount to the handlebars of a bike or scooter;
a power unit connector configured to mechanically and electrically connect a power unit to the mount;
wherein the power unit connector comprises:
an electrical interface configured to electrically connecting to a power unit; and
first and second opposing surfaces for gripping a power unit therebetween.

2. The mount of claim 1, wherein the first opposing surface is provided on a first jaw and the second opposing surface is provided on a second jaw.

3. The mount of claim 2, wherein each of the first and second jaws has a length defined as the distance between a distal tip of the respective jaw and a base that connects the jaw to the rest of the mount; wherein the length of each of the first and second jaws is less than about 40 mm.

4. The mount of claim 1, wherein the first and second opposing surfaces are configured to move towards and away from each other, between:
a gripping arrangement for gripping a power unit between the opposing surfaces; and
a release arrangement for releasing a power unit from the opposing surfaces.

5. The mount of claim 1, wherein the mount is configured to receive a power unit between the opposing surfaces and mechanically and electrically connect the power unit to the mount in a single motion.

6. The mount of a claim 1, wherein the electrical interface is provided on one of the opposing surfaces.

7. The mount of claim 6, wherein:
the first opposing surface is an upper surface configured to face downwards during use; and
the second opposing surface is a lower surface configured to face upwards during use;
wherein the electrical interface is provided on the first opposing surface.

8. The mount of claim 4, further comprising a lock, wherein the lock is configured to move between:
a locked configuration in which movement of the power unit connector from the gripping arrangement to the release arrangement is resisted; and
an unlocked configuration in which the power unit connector is free to move from the gripping arrangement to the release arrangement;
the mount further comprising a release configured to move the lock from the locked to the unlocked configuration.

9. The mount of claim 8, wherein the lock is configured to automatically move from the unlocked configuration to the locked configuration when a power unit is connected to the mount.

10. The mount of claim 1, further comprising at least one of:
a display for indicating a power output or battery level of a power unit connected to the mount;
a user interface for adjusting the power output level of a power unit connected to the mount.

11. The mount of claim 1, further comprising:
a first part having the attachment device; and
a second part having the power unit connector;
wherein the first and second parts are configured to attach and detach from one another.

12. The mount of claim 1, further comprising a wireless communication device.

13. A power apparatus for a bike or scooter, the power apparatus comprising:
a mount according to claim 1; and
a power unit.

14. The power apparatus of claim 13, wherein the power unit has a maximum length of 250 mm, a maximum width of 120 mm and a maximum depth of 40 mm.

15. The power apparatus according to claim 13, further comprising a power bridge configured to combine a plurality of power units into a single power supply;
wherein the power apparatus is configured such that the power unit can be connected to and disconnected from the mount directly, and a plurality of power units can be collectively connected to and disconnected from the mount via the power bridge, for allowing a user to selectively connect one, or multiple, power units to the mount.

16. A modular power apparatus for a bike, the power apparatus comprising:
a mount for attaching to a bike
a power unit; and
a power bridge configured to combine a plurality of power units into a single power supply;
wherein the power apparatus is configured such that the power unit can be connected to and disconnected from the mount directly, and a plurality of power units can be collectively connected to and disconnected from the mount via the power bridge, for allowing a user to selectively connect one, or multiple, power units to the mount.
